(19) United States
(12) Patent Application Publication
(10) Pub. No.: US 2025/0214510 A1
(43) Pub. Date: Jul. 3, 2025

(54) DEVICE FOR ADJUSTING A VIEWING MEANS ASSEMBLY, VIEWING MEANS DEVICE, AND VEHICLE COMPRISING SUCH A DEVICE

(71) Applicant: MCi (Mirror Controls International) Netherlands B.V., Woerden (NL)

(72) Inventor: Paulus Gerardus Maria VAN STIPHOUT, Woerden (NL)

(73) Assignee: MCi (Mirror Controls International) Netherlands B.V., Woerden (NL)

(21) Appl. No.: 18/852,180

(22) PCT Filed: Mar. 28, 2023
(86) PCT No.: PCT/NL2023/050159

§ 371 Date: Sep. 27, 2024

(30) Foreign Application Priority Data
Mar. 29, 2022 (DE) 102022107428.5

(51) Int. Cl. B60R 1/12; B60R 1/072

(52) U.S. Cl. CPC B60R 1/12; B60R 1/072; B60R 2001/1253

(57) ABSTRACT

The invention relates to a device for adjusting a viewing means assembly, comprising an installation frame and a support frame arranged together on a base part by means of a first joint assembly. The installation frame is further arranged on the support frame by means of a second joint assembly. The installation frame can be rotated relative to the base part only about a first pivot axis and pivoted relative to the support frame only about a second joint axis transverse to a first joint axis. The first joint assembly comprises a joint body bearing assembly. The second joint assembly comprises a counter bearing assembly, comprising at least one bearing means and at least one complementary counter bearing means, which can be guided together in a sliding manner such that the installation frame can be pivoted relative to the support frame only about the second joint axis.

The present invention relates to a device for adjusting a viewing means assembly, such as a mirror arrangement or a camera arrangement for a motor vehicle, comprising a base part, an installation frame, and a support frame, the base part being designed in particular for attachment to a body of a motor vehicle, and the installation frame being designed for mounting a viewing means, such as a mirror or a camera.

Such devices are known from the prior art, for example in the form of exterior mirrors for motor vehicles. They make it possible, usually by electrical means, to adjust the viewing means assemblies to the requirements of a motor vehicle operator. For example, they enable the viewing means assembly to be pivoted about multiple axes, for example in an upward and a downward direction, but also in a horizontal direction, in order to adapt the field of view to the requirements of the vehicle operator. In addition to adapting the field of vision, it is also usually possible to arrange the viewing means between a parking position or a retracted position and an extended position for operating the motor vehicle.

The structure of such devices comprises a plurality of components, many of which are force-coupled to one another to allow pivoting. In addition, protective devices are usually provided to enable the viewing means assembly to move when external forces act on it, for example, in order to prevent damage to the same. In addition to mostly electrically driven actuators, overload clutches such as slip clutches or similar safety devices are also provided in this case.

The disadvantage of the known devices lies particularly in their very complex and multi-part construction, which not only entails high costs in terms of parts production and parts storage, but also in the assembly of the respective devices.

It is therefore the object of the present invention to provide a more cost-effective, more durable, and less complex device.

This object is achieved by a device for adjusting a viewing means assembly, a viewing means device, and a vehicle, each provided with such a device, according to the independent claims.

In particular, this object is achieved by a device for adjusting a viewing means assembly, such as a mirror arrangement or a camera arrangement for a motor vehicle, comprising a base part, an installation frame, and a support frame, wherein the base part is designed in particular for attachment to a body of the motor vehicle, the installation frame is designed for mounting a viewing means, such as a mirror or a camera, the support frame is arranged on the base part by means of a first joint assembly such that it can be rotated relative to the base part only about a first joint axis A1, which extends in a substantially upward direction, namely between a retracted position in which the support frame is, for example, aligned substantially along the body of the motor vehicle, and an extended position in which the support frame is, for example, aligned substantially transversely to the body, the installation frame is arranged on the support frame by means of a second joint assembly such that it can be pivoted relative to the support frame only about a second joint axis A2, which extends substantially transversely to the first joint axis A1, the first joint assembly comprises a joint head bearing assembly with a joint head on the base part and a joint socket on the support frame, wherein the joint head is received by the joint socket, the second joint assembly comprises a cradle bearing assembly, with at least one bearing means arranged on the installation frame and at least one complementary counter-bearing means arranged on the support frame, which are slidingly guided with one another in such a way that the installation frame can only pivot about the second joint axis A2 relative to the support frame, the installation frame has an intermediate socket which is arranged between the joint socket and the joint head, the intermediate socket is rotationally fixed by the bearing means relative to the joint socket about the first joint axis A1 and can be rotated relative to the joint head together with the joint socket about the first joint axis A1, and wherein at least one sliding ring is optionally arranged between the joint head and the intermediate socket, which sliding ring forms a plain bearing between the joint head and the intermediate socket by means of which the installation frame can be slidably rotated relative to the base part about the first joint axis A1 and about the second joint axis A2.

In addition, this object is achieved by a viewing means assembly and by a vehicle with such a respective device.

It should be noted that, within the scope of the invention and with respect to the said first joint assembly and to the joint head bearing assembly, the joint head can also be arranged on the support frame and the joint socket on the base part. For ease of understanding and consistency of the present description, the joint head is optionally also understood to refer to a joint socket if the joint socket on the support frame is then understood accordingly to be the joint head. All embodiments described herein can be transferred identically to such a construction, in which case the aforementioned substitution of the joint socket and joint head must be carried out.

Within the scope of the invention, the term “viewing means” includes a mirror or a camera, inter alia, as mentioned above. However, it can also be understood to mean other arrangements and components which serve to better control a motor vehicle or similar vehicle. This includes, for example, lidar or IR sensors, blind spot indicators, heating devices, etc., which can be operatively connected to such a viewing means assembly.

The term “joint head bearing” is optionally understood to mean a bearing in which the joint head is received by the joint socket in such a way that it is movable and, in particular, rotatable in the joint socket, with interposition of the intermediate socket, about at least one axis, and here about the first joint axis A1.

Within the scope of the invention, a cradle bearing assembly is optionally understood to mean that only a relative movement between the support frame and the installation frame about the second joint axis is enabled. Optionally, plain bearing assemblies are provided here in which the bearing means on the installation frame are slidingly guided with counter-bearing means on the support frame. Special embodiments of this cradle bearing assembly will be discussed in greater detail below.

Within the scope of the invention, an upward direction is optionally understood to mean a vertical direction. The upward direction is optionally selected in relation to the required orientation of the viewing means assembly and, in particular, of the viewing means. The vertical direction can be the direction of gravity, particularly when a vehicle on which the device is arranged is horizontally aligned.

Within the scope of the invention, a socket is understood to mean an optionally concavely shaped component. An inner wall of the socket forms the concave wall part. An outer wall forms the opposite wall part, optionally a possibly existing resulting convex wall part.

It is conceivable for at least one viewing means to be substantially rigidly attached to the installation frame and, in particular, for all viewing means to be substantially rigidly attached. The combination of support frame, installation frame, and base part and the corresponding bearing design allows the viewing means to be pivoted together with the installation frame about the first and second joint axes, with only a reduced number of joint components being required for this purpose. The base part forms a central component that accommodates both the support frame and the installation frame, the installation frame being mounted on the support frame and being pivotable about an axis relative to the support frame.

When a viewing means is arranged on the installation frame, a pivoting movement of the viewing means about the second joint axis, particularly in an upward and downward direction, can take place via the installation frame, for example, while a pivoting movement, for example in an inward and outward direction, can take place about the first joint axis by rotating the support frame together with the installation frame about the first axis. Accordingly, the viewing means can be pivoted, for example, between a retracted and an extended position. It is also possible to use this arrangement to correct the viewing angle of the viewing means on the installation frame, for example toward or away from the vehicle body. This viewing means correction or the pivoting of the viewing means about the first joint axis can be performed independently of the folding-in and folding-out between the retracted and extended positions. Optionally, the device combines both the movement of the viewing means, for example between an operating and a parking position, and an adjustment in order to provide the driver with an optimal viewing angle.

Optionally, a main extension axis of the base part extends coaxially with the first joint axis. Optionally, a main extension axis and, in particular, a rotation axis of the joint head and/or the intermediate socket extends coaxially with this first joint axis. The same optionally applies to the sliding ring, in which case it is possible, in particular, for a circle center to be arranged on the first joint axis. Optionally, the joint head and the base part can be detachably connected to each other. An integrated design is also possible, however. Optionally, the joint head can be pushed onto the base part in the form of a slip-on cap; as mentioned, this also applies when the joint head is embodied as a joint socket.

It is optional that an inner wall of the intermediate cup and an outer wall of the joint head be spaced apart from each other to form a relative movement gap, the sliding ring being mounted in this relative movement gap between the intermediate cup and the joint head under bearing pressure. The relative movement gap is optionally designed such that it extends between the joint head and the intermediate socket in such a way that there is no direct contact between the joint head and the intermediate socket during any and all relative deflections between the joint head and the intermediate socket. The sliding ring is optionally designed such that it can transfer a vertical force, in particular coaxially with the first joint axis, from the installation frame to the base part.

A corresponding relative movement gap can be formed between the inner wall of the joint socket and the outer wall of the intermediate joint socket. The bearing means and counter-bearing means optionally guarantee that this relative movement gap is maintained during the pivoting movement of the installation frame relative to the support frame and, in particular, that there is no contact between the inner wall of the joint socket and the outer wall of the intermediate socket.

The arrangement of the sliding ring between the intermediate socket and the joint head enables the installation frame to be mounted so as to be rotatable relative to the base part about the first joint axis (together with the support frame) and about the second joint axis (on its own). The coupling between the installation frame and the support frame ensures that the support frame can be rotated relative to the base part about the first joint axis. The use of the sliding ring allows for a long-lasting joint head bearing assembly that is subject to very little wear. In particular, dirt that is located between the joint head and the intermediate socket can be easily removed via the relative movement gap. In addition, the design of the sliding ring guarantees a constant range of motion between the installation frame and the base part, since the sliding ring is subject to very little deformation. The adjustment of the rotational force required for the rotation or pivot movements is also made easier by the sliding ring, since only minor changes in the clearance between the installation frame and the base part occur over the course of operation.

Optionally, the sliding ring is arranged between the joint head and the intermediate socket in such a way that it forms a bearing by means of which the installation frame and, in particular, the intermediate socket can be pivoted about the second axis relative to the base part or the joint head, and, in particular, can be pivoted in a sliding manner. In this case, a plain bearing can also be formed between the intermediate socket, sliding ring, and joint head. During a movement about the second joint axis, particularly in this case, the sliding ring optionally moves relative to the joint head and/or relative to the intermediate socket about the second joint axis. In particular, it moves along the inner wall of the intermediate socket and/or the outer wall of the joint head.

Optionally, the sliding ring is made of metal, ceramic, or glass. Optionally, it has a Brinell hardness of between 200 and 900 HB. A sliding ring designed in this way reduces the wear of the bearing assembly. The design and arrangement of the sliding ring between the intermediate socket and the joint head makes it possible to take into account shrinkages and/or enlargements of the installation frame, base part, and support frame, which are optionally manufactured as plastic components, without changing the basic properties of the device.

Optionally, the outer wall of the joint head and/or the inner wall of the intermediate socket have, at least in some portions, a geometry that is rotationally symmetrical about the first joint axis, in particular a geometry that is spherical at least in some portions. It is conceivable for the joint head on the outer wall side or the outer wall of the joint head, and the intermediate socket on the inner wall side or the inner wall of the intermediate socket to be embodied as geometric bodies or surfaces that are complementary to one another. In particular, both can be embodied as spherical bodies. However, it is also conceivable to form different geometries relative to each other. For example, the joint head can be embodied at least in some portions as a spherical body and the intermediate socket can be embodied at least in some portions as a different solid body. For example, the intermediate socket can have the geometry of a cone disc in some portions. The same applies in the reverse construction for the joint head.

It is also conceivable to arrange channels on the intermediate socket and, in particular, the inner wall of the intermediate socket and/or the joint head or the outer wall of the joint head, which channels improve the removal of contaminants, and, in particular, particles in the relative movement gap. Such channels can, for example, extend with their main extension axis in the vertical direction, in particular downward in the direction of the first joint axis. Optionally, it is also conceivable to form corresponding recesses, elevations, depressions, or gaps on the sliding ring which enable the removal of dirt in the relative movement gap. These can be aligned with such channels to enable improved removal of contaminants and especially particles.

Optionally, the intermediate socket has a feedthrough through which the base part, in particular a shaft of the base part, can be guided through to the support frame, optionally from an outer side of the support frame to the inner side thereof. Optionally, it is conceivable that the shaft can be guided through the intermediate socket feedthrough in such a way that the intermediate socket completely surrounds the shaft. The feedthrough can be designed to be complementary to the shaft in such a way that the edges of the feedthrough (which can include edges facing the feedthrough which delimit the feedthrough) do not come into contact with the shaft in certain portions. Optionally, there is no restraint force between the shaft and the feedthrough, at least in some sections. It is conceivable for the duct or edges of the duct to serve as a pivot stop in some areas. This applies particularly when the installation frame is pivoted about the second joint axis, as will be described in detail below. At least a part of the base part and, in particular, a shaft can rest against such a pivot stop in a pivot-preventing manner.

Optionally, a feedthrough length DL of the feedthrough, which extends in a circumferential direction U2 around the second joint axis on the outer wall of the intermediate socket, is designed such that a pivot clearance is formed in this circumferential direction U2 between the base part and, in particular, the shaft of the base part and the intermediate socket, which allows a movement of the intermediate socket relative to the shaft and, in particular, a pivoting movement around the second joint socket. Optionally, the feedthrough is embodied as a slot that extends in the direction of the pivoting movement axis A3. The pivot movement axis A3 optionally extends transversely to the first joint axis A1 and the second joint axis A2. It describes the direction of movement that the edges of the feedthrough in particular follow when the installation frame is pivoted about the second joint axis relative to the base part.

In accordance with the above passages, an optional feedthrough is provided which is embodied as a free space in the intermediate socket and enables the base part to be guided through the intermediate socket. This feedthrough makes it possible to optionally insert the base part with a receiving part formed thereon. The receiving part can be formed on the joint head. As will be described later, this receiving part can be used, for example, to form a slip or similar clutch. Such a receiving part also optionally allows for the arrangement of fixing means which, for example, push the support frame in the direction of the joint head and the base part while pressing the intermediate socket between them. Optionally, a fixing means is provided in the form of a pre-tensioning means, for example a compression spring, which presses the joint socket and/or the intermediate socket against the joint head, thus effecting a constant bearing pressure between the intermediate socket, sliding ring, and joint head.

Such a fixing means can be force-coupled to the base part and, in particular, to the above receiving part.

The feedthrough is optionally designed to allow the installation frame to be pivoted about the second joint axis in two opposite directions. This enables a viewing means attached to the installation frame to be pivoted up and down, for example. As already mentioned, end regions and, in particular, edges of the feedthrough and, in particular, end regions of the feedthrough embodied as an elongate hole can serve as stop means which prevent further pivoting of the installation frame relative to the base part. Optionally, stop means specifically designed for this function can be provided on the intermediate socket and/or counter-stop means on the base part. Optionally, stop means such as projections but also damping means can be provided in some portions, particularly at the edges of the feedthrough. It is conceivable for the length of the feedthrough and, in particular, the length of the elongate hole to define the maximum pivot angle about the second joint axis. The longer the slot, the larger the optional pivot angle.

Optionally, the intermediate socket has an upper bearing groove on its inner wall, optionally concentric with the first joint axis, in which the sliding ring is mounted and optionally fixed against movement relative to the intermediate socket in the upward direction, or the joint head has a lower bearing groove on its outer wall, optionally concentric with the first joint axis, in which the sliding ring is mounted and optionally fixed against movement relative to the joint head in the downward direction. It is conceivable for the sliding ring to be mounted on the inner wall of the intermediate wall and/or the outer wall of the joint head in such a way that it is fixed relative to one of these components, i.e., the intermediate socket or the joint head, and moves together therewith during rotation about the first joint axis. It is also conceivable to design the joint head to be freely supported so that it moves freely about the first joint axis relative to both components when the installation frame is pivoted relative to the base part or the intermediate socket relative to the joint head and/or moves freely about the second joint axis when the installation frame is pivoted relative to the base part. Particularly in this section, the definition of the upward movement and the downward movement optionally refers to a direction in a neutral position of the device, namely in a state in which the installation frame is not pivoted relative to the base part about the second joint axis.

It is conceivable to provide an upper bearing groove on the intermediate socket such that the sliding ring can be mounted therein in such a way that it moves with the installation frame during the pivoting movement of the installation frame relative to the base part about the second axis and optionally does not move in a pivoting manner relative to the base part. It is conceivable to provide a lower bearing groove on the joint head in such the sliding ring can be mounted therein in such a way that it moves with the joint head during the pivoting movement of the installation frame relative to the base part about the second axis and optionally does not move in a pivoting manner relative to the latter.

It is conceivable for the bearing groove to be designed in such a way that it allows a force transmission from the installation frame to the base part and, in particular, the joint head, thus enabling a vertical force to be transferred from top to bottom. It is conceivable to design the bearing groove in such a way that it prevents a change in the circumference of the sliding ring, in particular as a result of this vertical force. In this way, it is ensured, inter alia, that the abovementioned freedom of movement is maintained and that the inner wall of the intermediate socket and the outer wall of the joint head do not come into contact with each other, at least in some portions. The bearing groove can be used to fix the position of the sliding ring so that the sliding ring does not become wedged relative to the intermediate socket and/or the joint head. The bearing groove can extend concentrically with the first joint axis.

It is fundamentally conceivable to form a plurality of sliding rings or a plurality of bearing grooves, in which case each bearing groove is optionally designed to be complementary to the sliding ring. The bearing groove, as viewed in cross section, can have a geometry in which the sliding ring is at least partially received over its entire surface and is under bearing pressure with said bearing groove. It is also possible to design the bearing groove in such a way that, when viewed in cross section, it is only in contact with the sliding ring at certain points. For example, as viewed in cross section, the sliding ring can have a circular or similarly rounded outer wall, and the bearing groove can have straight inner walls, so that point bearings are created between the bearing groove and the sliding ring, and, optionally, linear bearings particularly in some portions in the circumferential direction. When viewed over the circumference of the sliding ring or the bearing groove, a linear bearing preferably results, particularly in some portions, between the sliding ring and the bearing groove. This also applies optionally to a bearing design without a bearing groove, i.e., between the intermediate socket and the sliding ring and/or the joint head and the sliding ring. Here too, linear bearings can be optionally present at least in some portions. This applies in particular if there are discharge channels between the sliding ring and the intermediate socket or between the sliding ring and the joint head which, as previously mentioned, serve to drain away contaminants within the relative movement clearance.

Optionally, the sliding ring has a fixing means and the intermediate socket, or the joint head has a counter-fixing means, or vice versa, which engage with one another in such a way that the sliding ring is fixed relative to the intermediate socket or to the joint head against rotation about the first joint axis A1, the fixing means optionally having at least one projection which protrudes from the rotation axis A4, optionally from the sliding ring plane, of the sliding ring, and the counter-fixing means having at least one complementary projection receptacle. This can also apply conversely

Optionally, the counter-fixing means or the fixing means can be formed in an upper bearing groove on the intermediate socket or a lower bearing groove of the joint head.

The sliding ring can, for example, be fixed to the inner wall of the intermediate wall in such a way that it moves together with the intermediate socket relative to the base part when the base part is moved relative to the installation frame about the first joint axis and/or the second joint axis. The same applies to the arrangement of the sliding ring on the base part or the joint head. A fixing means can, for example, have at least one projection on the sliding ring which can be coupled to a projection receptacle as a counter-fixing means. A counter-fixing means can also have at least one projection which can be coupled to a corresponding projection receptacle as a fixing means.

Optionally, the sliding ring is embodied as an open sliding ring, in which case at least one free end region of the sliding ring is embodied as a fixing means. Such a free end region can be optionally embodied as a projection and, also optionally, as a projection that is bent out from its rotation axis A4, optionally from the sliding ring plane of the sliding ring.

Optionally, it is conceivable for at least one free end region of the sliding ring to be rounded. This prevents damage to the sliding ring surfaces, for example to the inner wall of the intermediate socket and/or the outer wall of the joint head.

Optionally, the second joint axis A2 and the first joint axis A1 intersect.

Optionally, the cradle bearing assembly is designed such that at least one bearing means of the installation frame and at least one counter-bearing means of the support frame form at least one strip bearing. Optionally, a bearing means is embodied as at least one, in particular circular-arc-shaped, convex bearing arch and/or a counter-bearing means is embodied as at least one, in particular circular-arc-shaped, concave bearing arch or has one such. Multiple such bearing arches can be used. The bearing means and counter-bearing means are preferably designed such that they form a plain bearing, it being possible for the bearing means to optionally slide along the counter-bearing means. It is conceivable for the bearing means to be embodied as a bearing strip over its entire length. The same optionally applies to the counter-bearing means. It is conceivable to design the bearing means in the form of a plurality of bearing strips which are arranged in a row next to one another and/or one behind the other and can slide along a counter-bearing means embodied as a strip bearing counter-bearing means. This also applies conversely. Here, for example, one or more support feet are provided as bearing means which sit on a corresponding bearing strip as a counter-bearing means and make the plain bearing possible. It is conceivable to provide appropriate coatings, lubricants, or similar devices between the bearing means and the counter-bearing means to improve bearing sliding.

In the scope of the invention, a strip bearing is understood to mean a bearing which has a strip-shaped bearing extension. According to the invention, the force is introduced in such a strip bearing as a distributed load, or as a linear load in the case of a minimally designed bearing width, the distributed load extending to a greater extent in a main direction of extension, which corresponds to the main direction of extension of the strip bearing, than transversely thereto.

It is conceivable for the bearing means and the counter-bearing means to be formed integrally with the installation frame or support frame. For example, the installation frame and/or the support frame can be manufactured as a cast component, with bearing means or counter-bearing means being cast integrally therewith.

The strip bearing is optionally embodied as a bearing with the smallest possible bearing width in relation to the bearing length. The strip bearing preferably has a bearing width which comprises 10%, optionally at least less than 8%, also optionally less than 5% of the bearing length. Optionally, the strip bearing is designed in such a way that it forms a linear bearing. Bearing length is the length of the bearing in the relative direction of movement of the bearing means and the counter-bearing means. The bearing width extends transversely thereto.

Optionally, at least one bearing means is formed on the outer wall of the intermediate socket and at least one counter-bearing means is formed on the inner wall of the joint socket. Within the scope of the invention, the inner wall of the joint socket is optionally the wall that forms the bearing surface of the joint socket and is opposite the joint head. The outer wall of the intermediate socket is optionally the wall that forms the intermediate socket on the outside and is opposite the joint socket. The outer wall of the joint head is optionally the wall that forms the outside of the joint head and is opposite the intermediate socket.

Optionally, the bearing means and counter-bearing means are arranged in the area in which the joint head bearing is also formed. Optionally, a plurality of bearing means and counter-bearing means are formed diametrically to the first joint axis relative to one another. Optionally, bearing means are embodied as sectors of a rotating body, the rotation axis of this rotating body lying on the second joint axis. In such an embodiment the bearing means is embodied, for example, as a bearing arch whose center lies on the second joint axis. The same applies to the counter-bearing means. The sectors of the rotating bodies of the bearing means and the counter-bearing means preferably have different radii. Bearing means and counter-bearing means preferably have bearing surfaces which are at least partially complementary to one another.

It is conceivable, as described below, for bearing means and/or counter-bearing means to be formed and operatively connected to corresponding actuators, particularly actuators which allow for an electrical or similar mechanically driven pivoting of the viewing means arrangement or which form corresponding engagement means for these actuators.

Optionally, at least one bearing means and at least one counter-bearing means have lateral guide means by means of which a fixation of the bearing means relative to the counter-bearing means in the direction of the second joint axis is provided for. Such bearing means and counter-bearing means can then, for example, form a sliding guide which enables pivoting about the second joint axis but prevents any other movement, particularly in a direction deviating from this second joint axis. Here, for example, movements that are translational in the direction of the second joint axis can be blocked. Such a translational fixation can also be provided via the bearing seat of the sliding ring between the intermediate socket and the joint head. In particular, fixation can be achieved through the geometrically complementary formation between the intermediate socket and the joint head.

In order to achieve the above fixation between the bearing means and the counter-bearing means, for example, lateral guide means can be provided on the bearing means and/or the counter-bearing means which slide with one another, particularly in a direction of the second joint axis. It is also conceivable to design the bearing means and counter-bearing means in such a way that a fixation between the intermediate socket and the joint socket is ensured in a direction along the first joint axis and, in particular, against a fixation away from each other. In such an embodiment, the bearing means can have an undercut relative to the counter-bearing means which produces this fixation. This is optionally also possible the other way around.

Optionally, at least one arc axis of at least one bearing means embodied as a convex bearing arch and/or an arc axis of at least one counter-bearing means embodied as a concave bearing base extends coaxially with the second joint axis. The arc axis is the axis along which the bearing arch or counter-bearing arch extends with a certain radius. Concave and convex optionally refer to the arrangement of the bearing arch on the component. Both the bearing arches and the counter-bearing arches optionally extend around the same joint axis. A concave bearing arch optionally forms a bearing surface on its concave inner side; a convex bearing arch optionally forms a convex, particularly complementary, bearing surface on its outer side.

Optionally, the installation frame is fixed relative to the support frame against movement in the direction of the first joint axis via a fixing means, in particular at least one fixing pin, which extends parallel to the second joint axis between the installation frame and the support frame and is mounted thereon via axle bearing means. Fixation is optionally carried out in the direction of the first joint axis in order to prevent the installation frame and the support frame from moving away from each other. An arrangement of fixing means and axle bearing means can be optionally configured such that they form a bearing means and a counter-bearing means for the cradle bearing assembly. In such a case in particular, the fixing means can then be optionally embodied as a bearing pin, while the counter-bearing means is embodied as at least one elongate hole through which the pin can be passed and moved along the arc axis of the elongate hole, thus enabling pivoting between the installation frame and the support frame.

Optionally, the device comprises an optionally electric first actuating means with a drive gear that is force-coupled to an output gear on the base part, in particular on a shaft, optionally at least partially surrounding the latter, so that the support frame can be rotated relative to the base part by means of the actuating means. Optionally, the actuating means transmits a force to the drive gear, which is then converted into a relative rotation between the base part and the support frame via the force coupling between the drive gear and the output gear. Optionally, it is also conceivable for an optionally electrical, second actuating means to be provided, with a drive gear which is force-coupled to an output gear on the installation frame and, in particular, to at least one bearing means of the installation frame, so that the installation frame can be pivoted relative to the support frame. It is also conceivable to provide the output gear on the counter-bearing means if this is provided on the installation frame. The drive gear and the output gear can, for example, be embodied as a gear structures that are coupled to one another. For example, a gear wheel arch can be provided on the bearing means or counter-bearing means to which a counter gear wheel, in particular a worm gear wheel, is force-coupled. Optionally, the force coupling between the drive gear and the output gear is provided in such a way that a pivot lock is formed when an external force is applied to the device which, without this force coupling, would cause the base part to pivot relative to the installation frame or the support frame to pivot relative to the installation frame. Such a locking mechanism can have lock decoupling when a threshold force is exceeded. Such constructions can be slip clutches or similar overload clutches, for example.

Optionally, the first and the second actuating means are both arranged on the support frame and, in particular, in an interior space of such a support frame.

Optionally, the installation frame at least partially encloses the support frame, and the support frame is optionally arranged and mounted in the form of a cradle within the installation frame. It is conceivable for the support frame within the installation frame to be substantially completely enclosed by the latter and/or for it to itself be substantially completely closed to form an interior space. When arranging the actuating means in particular, but also the drive gear and/or output gear, on the support frame, such a closed support frame provides safe encapsulation of the mostly sensitive components. It is also conceivable to design the support frame as a module in such a way that it can be inserted into the installation frame in a fully assembled form, in particular together with installed actuating means and corresponding gears. After the insertion of the support frame into the installation frame, or after the cradle bearing assembly is formed between the support frame and the installation frame, a viewing means cap can then be optionally arranged on the installation frame, so that the support frame is optionally substantially completely enclosed. The viewing means cap optionally includes a viewing means. A viewing means can also be arranged on the installation frame. The viewing means optionally includes a viewing means cap, which then substantially completely surrounds the support frame. The design of the support frame as a carrier, in particular for the actuating means and gears, results in a construction in which the installation frame can be made very slim. In particular, it is conceivable to attach only very thin components with reduced volume, such as a mirror, a camera, or a sensor, to the installation frame.

Optionally, the drive and/or output gears form a rotation lock so that a relative movement between the support frame and the base part is locked as a result of a torque applied externally to the support frame about the first joint axis, a slip or similar overload clutch being optionally provided which releases the rotation lock when a specified overload torque acts on the support frame, for example as a result of an object or a person colliding with a side end of a viewing means with which the support frame is force-coupled. Such a construction can also be provided between the support frame and the installation frame if, for example, a specified overload torque acts on the viewing means on the installation frame.

As already mentioned at the outset, the invention also relates to a viewing means device which is provided with a device described herein and to a vehicle which is provided with such a device. For reasons of redundancy, the corresponding embodiments will not be discussed in detail here, with reference being made nonetheless to all definitions of the device that can be formed on the corresponding viewing means or the vehicle.

Additional advantageous embodiments follow from the subclaims.

In the following, preferred exemplary embodiments of the invention will be explained in greater detail with reference to the enclosed drawings, in which:

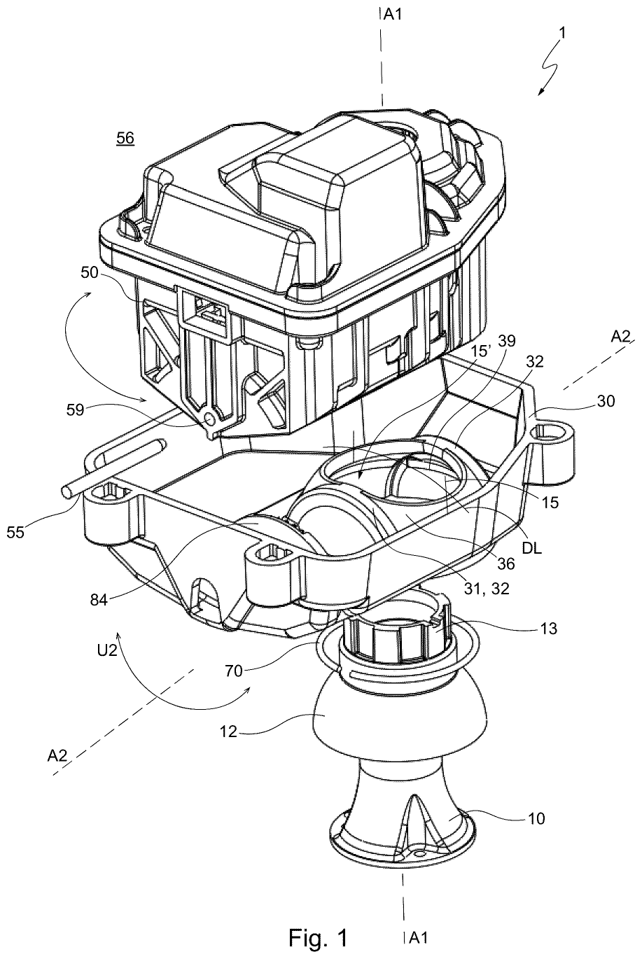

FIG. 1 shows a schematic sectional representation of a first embodiment of the device according to the invention;

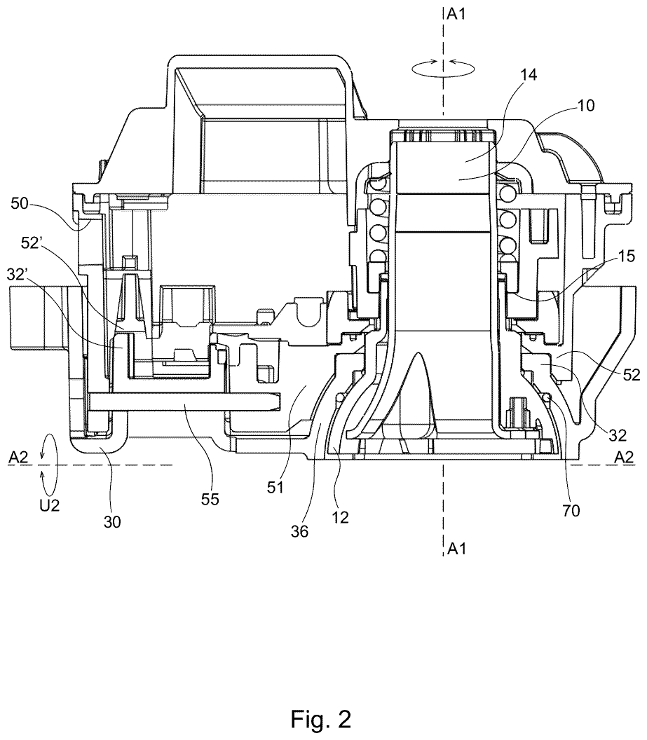

FIG. 2 shows a cross section through the embodiment according to FIG. 1;

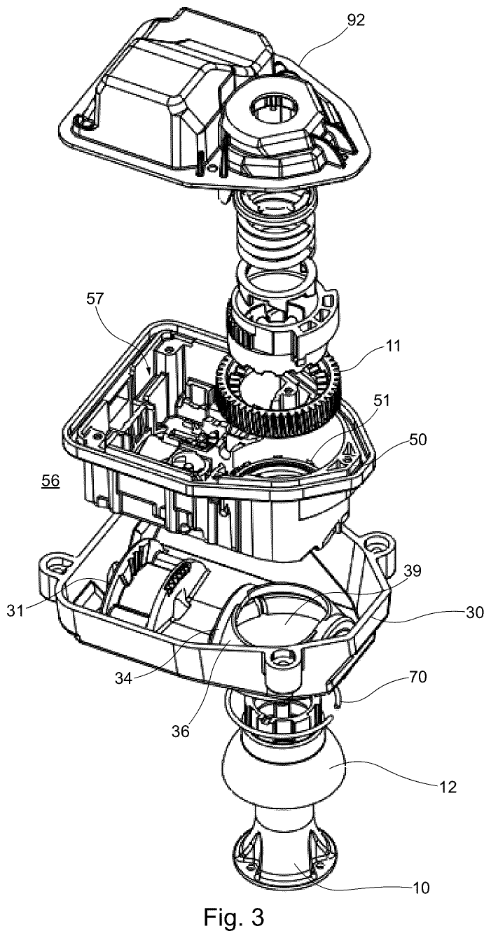

FIG. 3 shows another partially exploded representation of the embodiment according to FIG. 1;

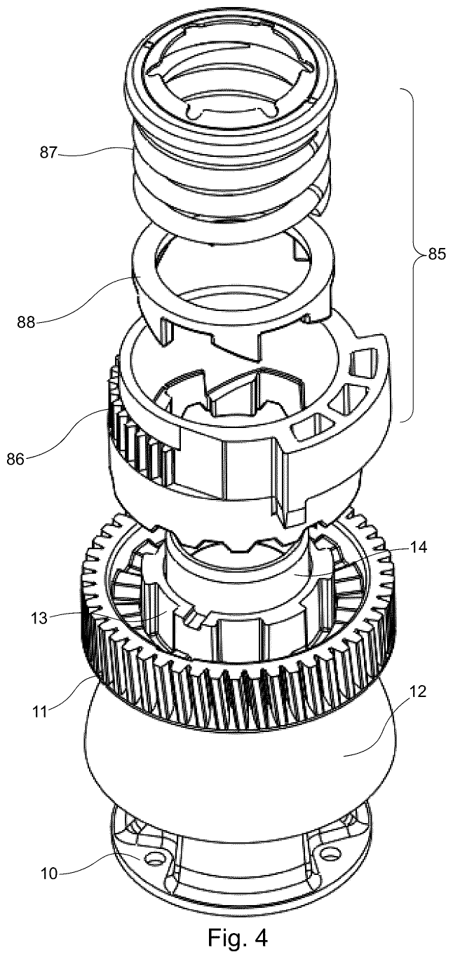

FIG. 4 shows a partially exploded, detailed representation of the embodiment according to FIG. 3;

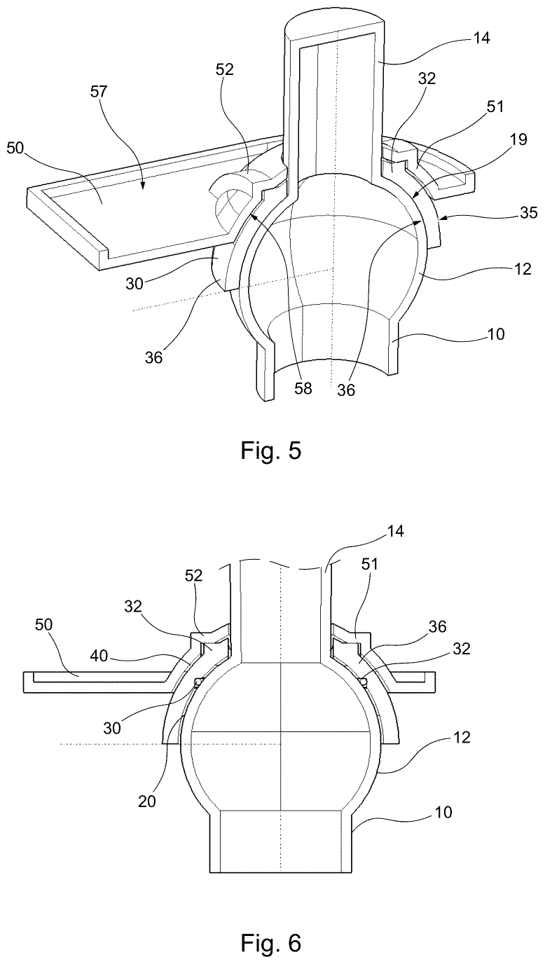

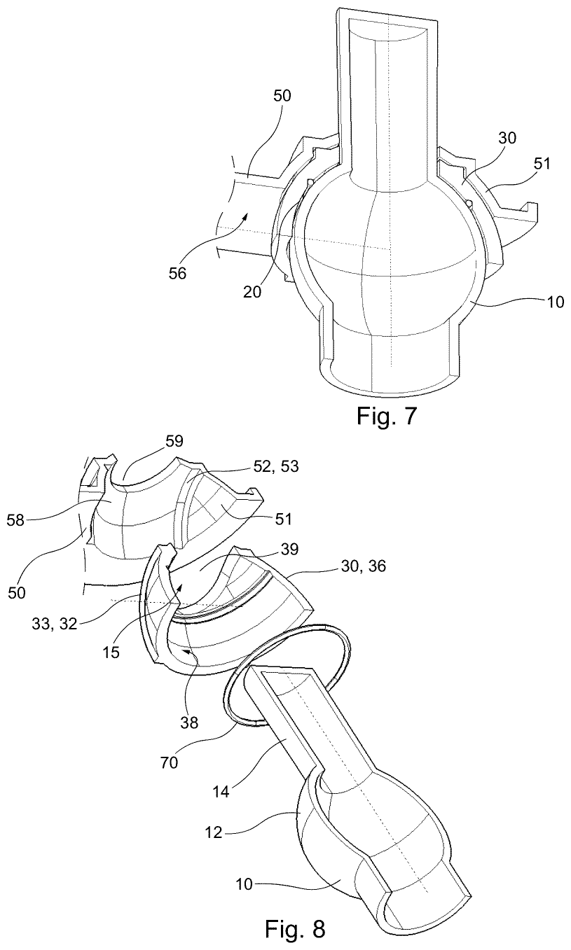

FIGS. 5-10 show partially sectional representations of another embodiment of the device according to the invention;

FIG. 11 shows a detailed view of a fixing means according to the illustration from FIG. 10;

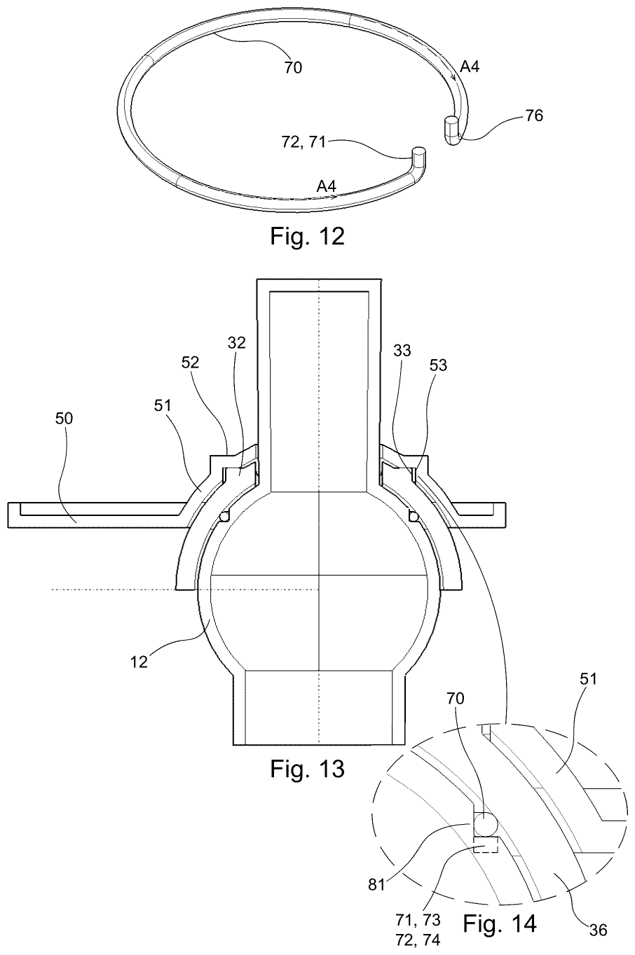

FIG. 12 shows a representation of an embodiment of the sliding ring according to the invention.

FIG. 13 shows a partially sectional view of another embodiment of the device according to the invention;

FIG. 14 shows a detailed view according to the illustration from FIG. 13;

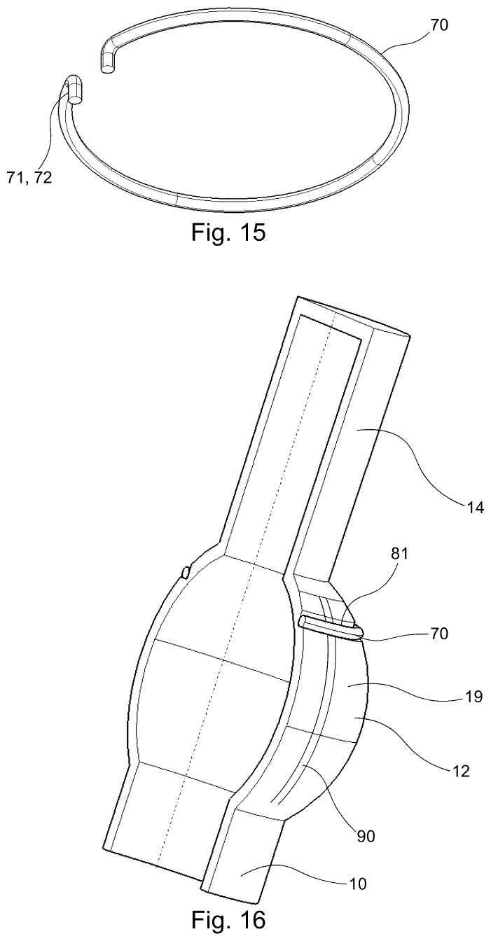

FIG. 15 shows a representation of another embodiment of the sliding ring according to the invention; and

FIG. 16 shows a detailed representation of a base part of the embodiment according to FIG. 13.

In the following, same reference numerals are used for identical and equivalent components, with superscripts sometimes being used.

Unless otherwise defined, all terms used herein (including technical and scientific terms) have the same meaning and, in particular, a meaning as commonly understood by a person of ordinary skill in the art when interpreted in the context of the description and the drawings. It is further understood that terms such as those defined in commonly used dictionaries are to be interpreted with reference to the technical field relevant here and not in an idealized or overly formal sense, unless explicitly so defined. In certain cases, a detailed description of well-known devices and methods may be omitted in order to avoid redundancy of the description. The description of particular embodiments and the terminology used therein is not intended to limit the invention. The singular forms “a” and “the” may also include the plural forms unless the context clearly suggests otherwise. The term “and/or” includes any and all combinations of one or more of the related listed items. It is understood that the terms “comprises” and/or “comprising” indicate the presence of said features but do not exclude the presence or addition of one or more other features. It is further understood that when a particular step of a method is specified as following another step, it may either follow that other step immediately or one or more intermediate steps may be performed before the particular step is performed, unless otherwise specified. In the same way, it is understood that when a connection between structures or components is described, this connection may be made directly or through intermediate structures or components, unless otherwise specified. Reference is made to the disclosure of any and all publications, patent applications, patents, and other literature mentioned herein in its entirety. In the event of a conflict, this specification, including its definitions, shall prevail.

The invention is described herein with reference to the accompanying drawings, in which embodiments of the invention are shown. The invention may, however, be embodied in many different forms and should not be construed as being limited to the embodiments set forth herein. Rather, the embodiments are specified herein so that the present disclosure will be thorough and complete and convey the scope of the invention to those skilled in the art in a complete but exemplary manner. The description of the exemplary embodiments should be read in conjunction with the accompanying drawings, which are intended to constitute part of the overall written description. In the drawings, the absolute and relative sizes of systems, components, layers, and regions may be exaggerated for clarity. Embodiments may be described using schematic and/or cross-sectional illustrations, idealized embodiments, and intermediate structures of the invention. Relative terms and derivatives thereof should be understood to refer to the orientation as described or shown in the drawing just discussed. These relative terms are intended to provide a clearer description and do not require that the system be constructed or operated in a particular orientation unless explicitly stated otherwise. Any of the disclosed devices or parts thereof may be combined together or separated into further parts unless specifically stated otherwise. The mere fact that certain measures are set out in different sections or claims is not intended to indicate that a combination of those measures cannot be advantageously carried out. In particular, any and all conceivable combinations of the claims are to be considered as being inherently disclosed. In this description, words such as “substantially”, “approximately”, or “generally/generally” are to be interpreted as including at least deviations of a dimension of 10% or less, preferably 5% or less, or deviations from a shape that would still fall within the scope of the relevant definition for a person skilled in the art, unless otherwise specified.

For clarity and conciseness of description, features are often described herein as part of one or separate embodiments; it will readily be understood, however, that the scope of the invention may include embodiments having combinations of all or some of the described features.

FIGS. 1 to 4 show different illustrations of a first embodiment of the device according to the invention. This device is also suitable for adjusting a viewing means assembly, such as a mirror arrangement or a camera arrangement for a motor vehicle. However, these arrangements are not shown in the illustrations, as they are known from the prior art.

The device according to the invention comprises a base part 10, an installation frame 30, and a support frame 50. As mentioned previously, the base part 10 is designed in particular for attachment to a body of the motor vehicle. Such an attachment can be rigid so that, in particular with reference to FIG. 1, the base part can serve as a fixed point of the device.

The installation frame 30 is designed for mounting a viewing means, for example a mirror, a camera, but also corresponding sensor means or other components which serve in particular to improve visibility and safety when driving a vehicle. This viewing means can be attached to the installation frame 30 in a substantially rigid manner so that it also moves as soon as the installation frame moves relative to the base part 10. According to the invention, no further adjustment device—e.g., no joint assembly, no actuator means, etc.—is optionally provided between the installation frame and the viewing means in order to move the viewing means relative to the installation frame.

The support frame 50 can be arranged on the base part 10 by means of a first joint assembly such that it can only be rotated relative to the base part about a first joint axis A1. This first joint axis A1 extends substantially in an upward direction. The definition of the term “upward” was already discussed in the introductory section. The support frame 10 can be rotated in such a way that it can be pivoted, for example, between an extended position, for example a driving position, and a retracted position, for example a parking position. Since the first joint assembly, as described below, is embodied as a joint head bearing assembly and the support frame 10 can be pivoted about the first joint axis A1, this pivoting is also referred to as rotation, the support frame 50 rotating about the first joint axis A1 relative to the base part 10. Optionally, the parts of this joint assembly are arranged concentrically with their joint surfaces around the first joint axis A1

As described in the introductory part, the extended position can also be defined as a position in which the support frame 50 is oriented substantially transversely to the body, for example. A retracted position can be defined such that the support frame is substantially aligned along the body of the vehicle, for example. As described below, the support frame is coupled to the installation frame in such a way that it can rotate together with the installation frame about the first axis of rotation.

The installation frame 30, for its part, is arranged on the support frame 50 by means of a second joint assembly such that it can only be pivoted relative to the support frame 50 about a second joint axis A2. As shown particularly in FIG. 1, this second joint axis extends transversely to the first joint axis.

As can be seen particularly in FIGS. 1 and 3, the arrangement between the support frame and the installation frame by means of the cradle bearing assembly optionally results in a cradle construction, the support frame being arranged in the form of a cradle within the installation frame. In the embodiment shown in FIG. 1, only a lower part of the installation frame 30 is shown. It is conceivable for the installation frame 30 to be formed by a cap and, in particular, as a viewing means cap such that it completely surrounds the support frame. A viewing means can also be embodied as such a cap or have such a cap. A pivoting of the support frame relative to the installation frame is therefore possible inside an installation frame 30 designed in this way.

The support frame 50 itself can also be embodied as a closed or partially closed component (see FIG. 1). Optionally, it contains on its inner side 57 (see FIG. 3) actuating means, such as motors and, in particular, electrically driven motors, by means of which a pivoting of the installation frame 30 relative to the support frame 50 and of the support frame 50 relative to the base part 10 is made possible. In addition to these actuating means, which are not shown in the figures for the sake of simplicity, corresponding drive gears can be provided in the support frame which are force-coupled to the actuating means. The drive gears, in turn, can then be coupled to corresponding output gears (see, for example, FIG. 4, reference numeral 11, or FIG. 3, reference numeral 31), thus enabling the corresponding rotational and pivoting movements. Output gears can also be arranged in the support frame.

The first joint assembly comprises a joint head bearing assembly having a joint head 12 on the base part 10 and a joint socket 51 on the support frame 50, the joint head 12 being received by the joint socket 51. As already explained in the introductory part, it is also possible to design the device in a correspondingly inverted manner, in which case the joint head is formed on the support frame 50 and the joint socket on the base part 10. All other components associated with this arrangement must then be adapted accordingly. This of course also applies to all features mentioned herein with regard to these components and their arrangement relative to the base part and the support frame.

In this embodiment, the joint head 12 is detachably connected to the base part 10. It is embodied as a plug-in head, meaning that it is pushed onto the base part via a shaft 14 of the base part and optionally fixed there around the first joint axis A1. The joint head 12 can also have receiving means 13 for the output gear 11 and/or for additional coupling devices, for example a slip clutch or a similar overload clutch 85. When a predetermined overload torque is applied to the support frame 50, but of course also to the installation frame 30, which is coupled to the support frame 50, and, in particular, to a viewing means arranged on the installation frame 30, this overload clutch can release a force coupling, in particular between the drive and output gears between the support frame and the base part, thereby making an emergency rotation possible. One example of such an emergency rotation is the folding-in of an outside mirror when an external load is applied which causes an overload torque. By way of example, the overload clutch 85 is provided here with a plurality of coupling rings 86, 88, which are force-coupled by a compression spring 87 and press against the base part 10 or the joint head 12 with interposition of the support frame and the output gear 11. According to the invention, the parts of the overload clutch can also be arranged in the interior 57 of the support frame. For assembly purposes, the support frame optionally has a cover 92 which is detachably attached to the support frame 50. In this embodiment, the cover 92 can be designed such that it applies the preload required for the overload clutch 85 to the compression spring 87.

The joint head 12 and the joint socket 51 are optionally designed such that the joint socket 51 at least partially surrounds the joint head 12. Optionally, the joint socket 51 is designed such that it surrounds the joint head 12 in a substantially half-shell shape at most, so that, in the absence of any fixing means, the joint head 12 can be inserted into the joint socket 51, particularly in the direction of the first joint axis A1.

As shown in FIGS. 1 and 2, the installation frame 30 has an intermediate socket 36 which is arranged between the joint socket 51 and the joint head 12. This intermediate socket 36 is designed in such a way that it can also be received by the joint socket 51. The intermediate socket is also designed to accommodate the joint head. Applicable here as well is the previously given definition of the formation of the joint socket and the joint head or the joint socket and the joint head in order to enable mutual insertion and reception.

As shown particularly in FIG. 2, the joint socket, the intermediate socket, and the joint head form a layered arrangement in which the outer layer, namely the joint socket, and the innermost layer, namely the joint head, enclose the joint socket between them.

As is also shown, in addition to the first joint assembly, embodied as a joint head bearing assembly, a second joint assembly is provided in the form of a cradle bearing assembly. This comprises at least one bearing means 32 arranged on the installation frame and at least one complementary counter-bearing means 52 arranged on the support frame 50. These are slidingly guided with each other in such a way that the installation frame 30 can only pivot about the second joint axis A2 relative to the support frame 50 via these bearing means and counter-bearing means. Optionally, the bearing means and counter-bearing means of the cradle bearing assembly form a plain bearing.

According to the invention, the intermediate socket 36 is rotationally fixed relative to the joint socket 51 about the first joint axis A1 by the bearing means 32 and/or the counter-bearing means 52. Among other things, it can be rotated relative to the joint head 12 only together with the joint socket 51 about the first joint axis A1, namely when the support frame 50 executes a rotation relative to the base part 10, for example via an electrical actuating means. By virtue of the cradle bearing assembly, the installation frame can be pivoted relative to the support frame.

When a viewing means is arranged on the installation frame 30, a pivoting movement of the viewing means about the second joint axis, particularly in an upward and downward direction, can take place via the installation frame, for example, while a pivoting movement, for example in an inward and outward direction, can take place about the first joint axis by rotating the support frame together with the installation frame. Accordingly, the viewing means can be pivoted, for example, between a retracted and an extended position. However, it is also possible to use this arrangement to correct the viewing angle of the viewing means on the installation frame, for example toward or away from the vehicle body. This viewing means correction or the pivoting of the viewing means about the first joint axis can be performed independently of the folding-in and folding-out between the retracted and extended positions. Optionally, the device combines both the movement of the viewing means, for example between an operating and a parking position, and an adjustment in order to provide the driver with an optimal viewing angle.

As can be seen particularly in FIGS. 1 to 3, at least one sliding ring 70 is arranged between the joint head 12 and the intermediate socket 36 which forms a plain bearing between the joint head 12 and the intermediate socket 36 by means of which the installation frame 30 can be slidably rotated relative to the base part 10 about the first joint axis A1. Optionally, the intermediate socket 36 and the joint head 12 form a press fit via the sliding ring 70, with bearing forces being diverted from the installation frame 30 or support frame 50 via the sliding ring 70 to the joint head 12 or the base part 10, particularly in the direction of the first joint axis A1.

Optionally, the sliding ring 70 is arranged between the joint head 12 and the intermediate socket 36 in such a way that it forms a sliding bearing by means of which the installation frame 30 and, in particular, the intermediate socket can be pivoted about the second axis relative to the base part 10 or the joint head, and, in particular, can be pivoted in a sliding manner. In this case, a plain bearing can also be formed between the intermediate socket, sliding ring, and joint head. During a movement about the second joint axis, particularly in this case, the sliding ring optionally moves relative to the joint head and/or relative to the intermediate socket about the second joint axis. In particular, it moves along the inner wall of the intermediate socket and/or the outer wall of the joint head.

Optionally, as mentioned, when the installation frame 30 pivots about the second joint axis A2, the sliding ring also moves in a pivoting movement about the second joint axis relative to the intermediate socket 36 and/or the joint head 12. This relative movement optionally depends, inter alia, on whether the sliding ring 70 is fixed to the intermediate socket or the joint head 12, as will be described in detail below.

It should be noted that the pivot angles of the support frame relative to the base frame can be optionally larger than the pivot angles between the support frame and the installation frame. The device is optionally designed such that a rotation angle about the first axis of rotation between the support frame 50 and the base part 10 is produced, which is at least 60 percent, optionally at least 70 percent and, also optionally, at least 80 percent greater than the pivot angle of the installation frame 30 relative to the support frame 50. Since the installation frame 30 is cradle-mounted on the support frame 50, this naturally also applies to the pivot angle of the installation frame 30 relative to the base part 10 about the second joint axis.

Optionally, the sliding ring 70 is arranged concentrically with the first joint axis A1. Optionally, the joint head 12 is arranged concentrically with the first joint axis A1 and, optionally, the intermediate socket and/or the joint socket are concentric with the first joint axis A1.

FIGS. 5 to 11 show another embodiment, which is similar to the embodiment according to FIGS. 1 to 4 are similar, in particular identical, in different views and detailed views. For the sake of simplicity, reference is optionally made with regard to the basic construction of this embodiment to the aforementioned passages concerning the previously described embodiment.

It can be seen particularly in FIG. 5 that an inner wall 38 of the intermediate socket 36 and an outer wall 19 of the joint head 12 are spaced apart from one another to form a relative movement gap 20. The sliding ring 70 is mounted in this relative movement gap 20 between the intermediate socket 36 and the joint head 12 under bearing pressure; a plain bearing is formed between the inner wall of the intermediate socket, the outer wall of the joint head, and the sliding ring. In this context in particular, the sliding ring is optionally made of metal, ceramic, or glass, and it optionally has a Brinell hardness of between 200 and 900 HB. This results in minimal wear on the sliding ring, which, for structural reasons, has to bear very high loads.

A corresponding relative movement gap 40 (see FIG. 6) can be formed between the inner wall 58 of the joint socket 51 and the outer wall 35 of the intermediate socket 36. The bearing means 32 and counter-bearing means 52 optionally guarantee that this relative movement gap 40 is maintained during the pivoting movement of the installation frame relative to the support frame. Optionally, the joint socket 51 and the intermediate socket 36 are in contact with each other exclusively via the correspondingly arranged bearing means 32 and/or counter-bearing means 52. The same optionally applies to the intermediate socket 36 and the joint head 12, which are in contact with each other exclusively via the sliding ring 70.

The mentioned relative movement spaces 20, 40 ensure a reproducible sliding resistance between the components that can be pivoted relative to each other and, in addition, optionally allow for the removal of contaminants that accumulate between the respective components. It is also conceivable to arrange appropriate sliding aids, such as greases and oils, but also coatings on and between the bearing means, counter-bearing means and sliding ring, which improve the sliding support of the components relative to one another.

As can be seen particularly in FIGS. 5 and 6, the outer wall 19 of the joint head 12 and/or the inner wall 38 of the intermediate socket 36 have, at least in some portions, a geometry that is rotationally symmetrical about the first joint axis A1, in particular a geometry that is spherical at least in some portions. In the embodiment shown here, the respective components—i.e., joint head 12 and intermediate socket 36—have spherical geometries with a common sphere center. They differ in their radii. The same applies to the joint socket 51, which also has a correspondingly rotationally symmetrical geometry in some portions and, in this embodiment, optionally a spherical geometry in some portions. The respective geometries of the joint head, intermediate socket, and joint socket are at least partially complementary to each other, making a sandwich arrangement of the respective components relative to each other possible. It is conceivable to design at least one component as a partially spherical component and to design the correspondingly assigned component with a different geometry. For example, the intermediate socket can have the geometry of a cone disc into the cone disc inner side of which the joint head 12 is fitted under interposition of the sliding ring 70. Such an arrangement can also be present between the joint socket 51 and the intermediate joint socket 36. It is also conceivable to design the geometries, in particular of the intermediate socket, at least in some portions in such a way that the inner wall 38 of the intermediate socket follows a different geometry than the outer wall 35. For instance, a spherical geometry can be provided on the inside at least in some portions, while a different geometry is formed on the outside, or vice versa.

As can be seen particularly in FIGS. 8 to 10 in detail, the intermediate socket 36 optionally has a feedthrough 39 through which the base part and, in particular, a shaft 14 of the base part can be guided to the support frame 50, optionally from an outer side 56 of the support frame 50 to an inner side 57 (see FIG. 3). This feedthrough 39 optionally has a feedthrough length DL (see FIG. 1) which extends in a circumferential direction U2 around the second joint axis A2 along the wall of the intermediate socket. The feedthrough is designed such that, in this circumferential direction U2, a pivot clearance 15 is formed between the base part 10, and, in particular, the shaft 14, and the intermediate socket 36, which enables a movement of the intermediate socket 36 relative to the base part 10 or the shaft 14 and, in particular, a pivoting movement about the second joint axis A2 (see also FIG. 1).

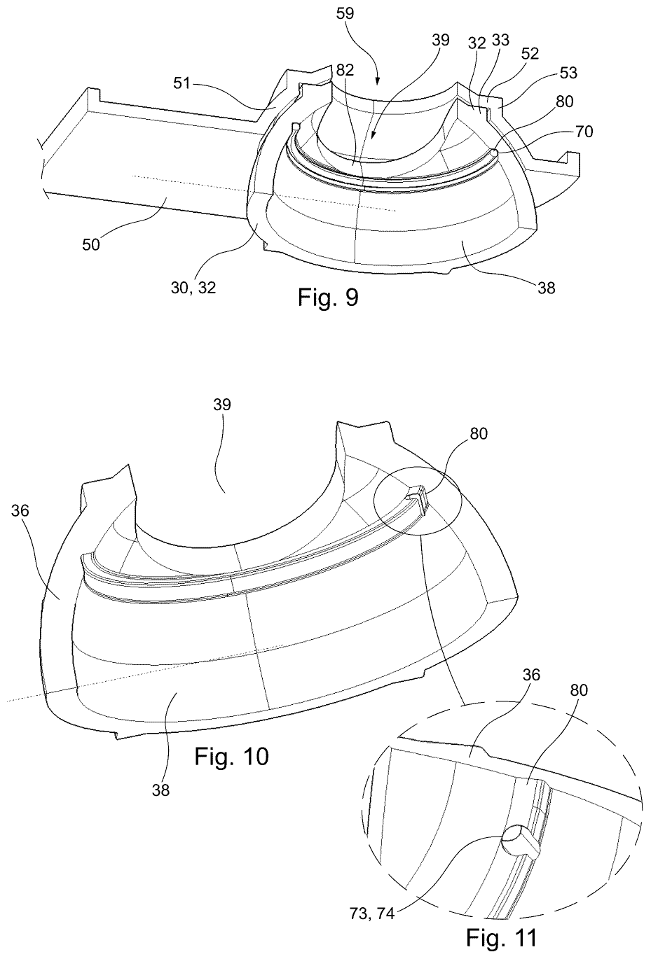

As is particularly shown in FIGS. 8 and 9, a feedthrough 59 is also optionally also provided at the joint socket 51 by means of which the base part 10 and, in particular, a shaft 14 can be guided from the outer side 56 into the interior or onto the inner side 57 of the support frame 50. This feedthrough 59 is optionally arranged concentrically with the first joint axis A1. It optionally surrounds the base part 10 and particularly the shaft 14 thereof completely, particularly in a circular manner. The feedthrough 59 is optionally designed such that, when the support frame 50 rotates relative to the base part 10, there is no contact between the support frame 50 and the base part 10. The feedthrough can have stop means and, in particular, guide means which serve to guide the support frame relative to the base part during rotation about the first joint axis. The stop means can, for example, abut in a guiding manner with counter-stop means against the base part, in particular against a shaft thereof.

Optionally, this feedthrough 59 is designed such that it at least partially covers the feedthrough 39 and, in particular, a feedthrough 39 of the intermediate socket which is embodied as an elongate hole. This prevents the penetration of dirt particles. In principle, it is conceivable to provide sealing means between the side edges of the feedthrough 39 or 59 which have a sealing effect at least partially with the base part 1 and, in particular, with the shaft.

Optionally, this feedthrough 39, as shown by way of example in this embodiment, is embodied as an elongate hole which extends in the direction of the pivoting movement axis A3 (see FIG. 2). This pivoting movement axis A3 represents the movement of the feedthrough or edges 82 (see FIG. 9) and, in particular, front side edges 82. These move in the direction of this pivoting movement axis A3. This pivoting movement axis A3 is arc-shaped, the arc formed optionally having a center on the second joint axis A2. Optionally, the feedthrough, and, in particular, a front side edge 82, moves along the pivoting movement axis A3 in an arc around the second joint axis A2.

It is conceivable, in particular, for the front side edges 82 of this feedthrough to have blocking means, so that a pivoting angle is limited by an abutment of these blocking means on the base part 10 and, in particular, the shaft thereof or a correspondingly provided counter-stop means. Optionally, these means are arranged diametrically to the first joint axis A1 at the feedthrough.

As shown by way of example in FIGS. 5 to 11, at least one upper bearing groove 80, which optionally extends concentrically with the first joint axis A1, is provided on the inner wall 38 of the intermediate socket 36 and in which the sliding ring 70 is mounted. In particular, the sliding ring 70 is optionally fixed against movement relative to the intermediate socket 36 in the upward direction, i.e., in the direction of the first joint axis A1.

As shown in FIGS. 13 to 16 for another embodiment, it is alternatively possible for the joint head 12 to have on its outer wall 19 a lower bearing groove 81 which optionally extends concentrically with the first joint axis A1 and in which the sliding ring 70 is mounted, and is optionally fixed against movement relative to the joint head 12 in a downward direction, i.e., along the first joint axis A1. Designs of these bearing grooves were explained particularly in the introductory part. The bearing grooves can be optionally used to fix the sliding ring to the component on which the bearing groove is formed, so that the sliding ring moves at least along one axis together with the component of the bearing groove. This fixation can be uniaxial or multiaxial.

The sliding ring 70 optionally has a fixing means 72, and the intermediate socket 36 or the joint head 12 (depending on the embodiment according to FIGS. 5 to 11 and 13 to 16) have a counter-fixing means, or vice versa, which engage with one another in such a way that the sliding ring 70 is fixed relative to the intermediate socket 36 or to the joint head 12 against rotation about the first joint axis A1. Fixing means and counter-fixing means can be designed such that the sliding ring is fixed relative to the intermediate socket or the joint head against movement, particularly in the direction of the first joint axis A1. The above refers to an orientation in which the installation frame is not pivoted about the second joint axis—the aforementioned neutral position.

Optionally, the fixing means 72 has at least one projection 71 which protrudes from the rotation axis A4 (see FIG. 12) and optionally from the sliding ring plane of the sliding ring 70, and the counter-fixing means 74 has at least one complementary projection receptacle 73, or vice versa. In this embodiment, the projection receptacle is a recess into which the projection 71 can be inserted and thereby fixes the sliding ring 70 in particular against rotation about the first joint axis (see FIG. 11). Depending on the design, the counter-fixing means can be located on the joint head or the intermediate socket. It is also conceivable to form a counter-fixing means on the sliding ring, for example in the form of a recess, and a fixing means on the intermediate socket or the joint head, for example in the form of a projection complementary to the recess. For such an embodiment, everything previously described regarding fixing means and counter-fixing means applies.

It is conceivable for the counter-fixing means 74 or the fixing means 72 to be arranged or formed in an upper bearing groove on the intermediate socket 36 or a lower bearing groove 81 of the joint head 12

In the embodiments shown here according to FIGS. 5 to 16, the sliding ring is optionally embodied as an open sliding ring 70. In the embodiments according to FIGS. 1 to 4, it is optionally embodied as a closed sliding ring. In the case of an open sliding ring 70, it is conceivable for at least one free end region 76 (see FIG. 12) of the sliding ring 70 to be embodied as a fixing means 72, optionally as a projection 71, and to also be optionally bent out of the rotation axis A4, optionally out of the sliding ring plane of the sliding ring 70. It is also conceivable for a free end region 76 of the sliding ring to be rounded.

As mentioned previously, the different designs of the bearing grooves 80, 81 for the sliding ring are shown in FIGS. 5 to 11 and 13 to 16, respectively. In the embodiment according to FIGS. 13 to 16, at least one counter-fixing means 74 is embodied in the form of a projection receptacle on the joint head 12 into which the complementary fixing means 72 or a bent projection 71 of the sliding ring 70 can engage in a fixing manner.

As another example, FIG. 16 shows an embodiment in which at least one channel 90 is formed on an outer wall 19 of the joint head, which channel serves to remove contaminants in the movement clearance 20. This channel is covered by the sliding ring 70 to form a discharge space so that contaminants and, in particular, particles can also be discharged downward and, in particular, in the direction of the first joint axis A1. A corresponding construction can also be formed between the joint socket and the intermediate joint socket.

Optionally, the first and second joint axes intersect.

As can be seen particularly in FIGS. 1 and 5 to 7, it is conceivable that the cradle bearing assembly is designed such that at least one bearing means 32 of the installation frame 30 and at least one counter-bearing means 52 of the support frame 50 form at least one strip bearing; optionally, a bearing means 32 has at least one, in particular circular-arc-shaped, convex bearing arch 34 and/or a counter-bearing means 52 has at least one, in particular circular-arc-shaped, concave bearing arch 54. These arches are force-coupled with each other and, in particular, in force-coupled in a sliding manner. When the installation frame moves relative to the support frame about the second joint axis A2, the bearing means and the counter-bearing means slide relative to each other. Optionally, they form a guide. Lateral guide means 33, 53 can also be provided for this purpose. They can form a guide between the installation frame and the support frame when the installation frame is pivoted about the second joint axis. They can provide guidance and, in particular, blocking against movement of the installation frame relative to the support frame along the second joint axis.

It is also conceivable for bearing means 32 and counter-bearing means 52 to be formed outside the area of the joint socket 51, intermediate socket 36, and joint head 12. This is illustrated exemplarily in FIG. 1. In this embodiment, these externally arranged bearing means have output gears 31 which, in particular, are force-coupled with actuating means which are optionally arranged in the support frame. In particular, they are force-coupled to drive gears. However, output gears can also be designed without a bearing function.

It is also conceivable for at least one bearing means 32 to be formed on the outer wall 38 of the intermediate socket 36 and for at least one counter-bearing means 52 to be formed on the inner wall 58 of the joint socket 51. Optionally, bearing means and/or counter-bearing means are formed integrally with their respective associated components, i.e., intermediate socket or joint socket.

FIG. 6 in particular shows that it is possible for at least one bearing means 32 and at least one counter-bearing means 52 to have lateral guide means 33, 53 by means of which a fixation of the bearing means 32 relative to the counter-bearing means 52, and thus optionally also of the installation frame relative to the support frame, is provided against a force component acting in the direction of the second joint axis A2. Bearing means and counter-bearing means can form a guide for a movement of the installation frame in one direction about the second joint axis. In the event of a force acting on the installation frame or the support frame in the direction of the second joint axis, these lateral guide means 33, 53 optionally prevent the joint socket from striking the intermediate socket and/or maintain the relative movement gap 40.

It is conceivable for an arc axis of at least one bearing means 32 embodied as a concave bearing arc 34 and/or an arc axis of at least one counter-bearing means 52 embodied as a concave bearing arc 54 to extend about an axis which is coaxial with the second joint axis A2. This means that the arches can encircle the second joint axis in a circular arc, at least in some portions. The respective arches can have a common arc center which optionally lies on the second joint axis.

Optionally, a fixing means, optionally in the form of a pre-tensioning means—here for example a compression spring 87—is provided which presses the joint socket and/or the intermediate socket against the joint head, thus effect a constant bearing pressure between the intermediate socket, sliding ring, and joint head.

As is shown particularly in FIGS. 1 and 2, it is conceivable for the installation frame 30 to be fixed relative to the support frame 50 against movement in the direction of the first joint axis A1 via a fixing means, in particular a fixing pin 55, which optionally extends parallel to the second joint axis A2 between the installation frame 30 and the support frame 50 and is mounted thereon via axle bearing means 59. Such a fixation optionally ensures, particularly after the previously described overload clutch has been triggered, the cohesion of the components secured by the fixing pin or the fixing means. In this embodiment, the fixing means and, in particular, the fixing pin 55 in the component 84, which is optionally also embodied as a bearing means 32, is mounted in an elongate hole (not shown). This slot optionally also extends around the second joint axis A2 in a circular arc. When the installation frame 30 is pivoted relative to the support frame 50, the fixing means or the fixing pin 55 can slide along transversely to its axis of extension.

### LIST OF REFERENCE SYMBOLS

1 device
10 base part
11 output gear on the base part
12 joint head
13 receiving means
14 shaft
15 pivot clearance
19 outer wall of the joint head or outside
20 relative movement gap
30 installation frame
31 output gear on the installation frame
32 bearing means
33 lateral guide means
34 convex bearing arch
35 outer wall of the intermediate socket or outside
36 intermediate socket
38 inner wall of the intermediate socket or inside
39 feedthrough
40 relative movement gap
50 support frame
51 joint socket
52 counter-bearing means
53 lateral guide means
54 convex bearing arch
55 fixing means, in particular fixing pin
56 exterior or outside of the support frame
57 interior or inside of the support frame
58 inner wall of the joint socket
59 feedthrough
59 axle bearing means
70 sliding ring
71 projection
72 fixing means
73 projection receptacle
74 counter-fixing means
76 free end region
80 upper bearing groove
81 lower bearing groove
82 front edge of the feedthrough
84 component
85 overload clutch
86 coupling ring
87 compression spring
88 coupling ring
90 channel
92 cover
A1 first joint axis
A2 second joint axis
A3 pivot movement axis
A4 circumferential axis
DL feedthrough length
U2 circumferential direction

1. A device for adjusting a viewing means assembly, such as a mirror arrangement or a camera arrangement for a motor vehicle, comprising a base part, an installation frame, and a support frame, wherein:
the base part is designed in particular for attachment to a body of the motor vehicle,
the installation frame is designed for mounting a viewing means, such as a mirror or a camera,
the support frame is arranged on the base part by means of a first joint assembly such that it can be rotated relative to the base part only about a first joint axis (A1) which extends in a substantially upward direction, for example between a retracted position in which the support frame is, for example, aligned substantially along the body of the motor vehicle, and an extended position in which the support frame is, for example, aligned substantially transversely to the body,
the installation frame is arranged on the support frame by means of a second joint assembly such that it can be pivoted relative to the support frame only about a second joint axis (A2) which extends substantially transversely to the first joint axis (A1),
the first joint assembly comprises a joint head bearing assembly, with a joint head on the base part, and a joint socket on the support frame, the joint head being received by the joint socket,
the second joint assembly comprises a cradle bearing assembly,
with at least one bearing means arranged on the installation frame and at least one complementary counter-bearing means arranged on the support frame, which are slidingly guided with one another in such a way that the installation frame can only pivot about the second joint axis (A2) relative to the support frame,
the installation frame has an intermediate socket which is arranged between the joint socket and the joint head,
the intermediate socket is rotationally fixed relative to the joint socket about the first joint axis (A1) by the bearing means and the counter-bearing means and can be rotated relative to the joint head together with the joint socket about the first joint axis (A1), and wherein
at least one sliding ring is arranged between the joint head and the intermediate socket which forms a plain bearing between the joint head and the intermediate socket by means of which the installation frame can be slidably rotated relative to the base part about the first joint axis (A1) and about the second joint axis (A2).

2. The device according to claim 1, characterized in that:
an inner wall of the intermediate socket and an outer wall of the joint head are spaced apart from one another to form a relative movement gap, wherein the sliding ring is mounted in this relative movement gap between the intermediate socket and the joint head under bearing pressure.

3. The device according to claim 1, characterized in that the sliding ring is made of metal, ceramic, or glass and optionally has a Brinell hardness of between 200 and 900 HB.

4. The device according to claim 2, characterized in that:
an outer wall of the joint head and/or an inner wall of the intermediate socket has, at least in some portions, a geometry that is rotationally symmetrical about the first joint axis (A1), in particular a geometry that is spherical at least in some portions.

5. The device according to claim 1, characterized in that:
the intermediate socket has a feedthrough through which a shaft of the base part can be guided to the support frame, optionally from an outer side of the support frame to an inner side, wherein a feedthrough length (DL) of the feedthroug, which extends in a circumferential direction (U2) about the second joint axis (A2) on an outer wall of the intermediate socket, is designed such that, in this circumferential direction (U2), a pivot clearance is formed between the shaft of the base part and the intermediate socket which allows a movement of the intermediate socket relative to the shaft, and, in particular, a pivoting movement about the second joint axis (A2), the feedthrough being optionally embodied as an elongate hole that extends in the direction of the pivoting movement axis (A3).

6. The device according to claim 1, characterized in that:
the intermediate socket has on an inner wall an upper bearing groove which optionally extends concentrically with the first joint axis (A1) and in which the sliding ring is mounted, and is optionally fixed against movement relative to the intermediate socket in the upward direction, or
the joint head has on an outer wall a lower bearing groove which optionally extends concentrically with the first joint axis (A1) and in which the sliding ring is mounted and is optionally fixed against movement relative to the joint head in the downward direction and/or against rotation about the first joint axis (A1).

7. The device according to claim 1, characterized in that:
the sliding ring has a fixing means and the intermediate socket or the joint head has a counter-fixing means, or vice versa, which engage with one another in such a way that the sliding ring is fixed relative to the intermediate socket or to the joint head against rotation about the first joint axis (A1), wherein optionally the fixing means has at least one projection protruding from the rotation axis (A4), optionally out the sliding ring plane, of the sliding ring, and the counter-fixing means has at least one complementary projection receptacle, or vice versa.

8. The device according to claim 1, characterized in that:
the sliding ring is an open sliding ring, in which case at least one free end region of the sliding ring is optionally embodied as a fixing means, optionally as a projection, and, also optionally, is bent out of its rotation axis (A4), optionally out of the sliding ring plane of the sliding ring, and/or wherein a free end region of the sliding ring is optionally rounded.

9. The device according to claim 1, characterized in that:
the cradle bearing assembly is designed such that at least one bearing means of the installation frame and at least one counter-bearing means of the support frame form at least one strip bearing, wherein optionally a bearing means has at least one, in particular circular-arc-shaped, convex bearing arch, and/or a counter-bearing means has at least one, in particular circular-arc-shaped, concave bearing arch.

10. The device according to claim 9, characterized in that:
at least one bearing means is formed on an outer wall of the intermediate socket, and at least one counter-bearing means is formed on an inner wall of the joint socket.

11. The device according to claim 9, characterized in that:
at least one bearing means and at least one counter-bearing means have lateral guide means by means of which a fixation of the bearing means relative to the counter-bearing means in the direction of the second joint axis (A2) is provided for.

12. The device according to any one of the preceding claims claim 1, characterized in that:
the installation frame is fixed relative to the support frame against movement in the direction of the first joint axis (A1) via at least one fixing means, in particular a fixing pin, which extends parallel to the second joint axis (A2) between the installation frame and the support frame and is mounted thereon via axle bearing means.

13. The device according to claim 1, characterized in that:
the device comprises an optionally electrical first actuating means with a drive gear which is force-coupled to an output gear on the base part, in particular on a shaft, at least partially surrounding the latter, so that the support frame can be rotated relative to the base part, and/or
an optionally electrical second actuating means with a drive gear which is force-coupled to an output gear on the installation frame, and, in particular, to at least one bearing means of the installation frame, so that the installation frame can be pivoted relative to the support frame, both actuating means being arranged on the support frame.

14. The device according to claim 1, characterized in that:
the installation frame at least partially encloses the support frame, and the support frame is optionally arranged and mounted in the form of a cradle within the installation frame.

15. A viewing means assembly, provided with the device according to claim 1.

16. A vehicle, provided with the device according to claim 1.
